(19) United States
(12) Patent Application Publication
(10) Pub. No.: US 2001/0006997 A1
(43) Pub. Date: Jul. 5, 2001

(54) Polymer blend having good physical properties

(75) Inventors: Hung Dang Ngoc, Limeil Brevannes (FR); Agnes Marie Madeleine Louise De Loor, Guyancourt (FR)

Correspondence Address: The Goodyear Tire & Rubber Company, Department 823, 1144 East Market Street, Akron, OH, 44316-0001, US

(73) Assignee: The Goodyear Tire & Rubber Company

(21) Appl. No.: 09/769,636

(22) Filed: Jan. 25, 2001

Related U.S. Application Data
(62) Division of application No. 09/286,373, filed on Apr. 5, 1999, now abandoned.

(51) Int. Cl. C08F 8/00; C08L 23/26; C08L 31/04; C08L 33/08

(52) U.S. Cl. 525/192; 525/193; 525/194

(57) ABSTRACT

There is a need for halogen-free polymeric compositions that offer high tensile strength and high tear strength as well as increased heat and ultraviolet light resistance. For instance, it is particularly critical for polymers that are utilized in making skin compounds for automotive instrument and door panels to offer high modulus as well as to display excellent heat and ultraviolet light resistance. This invention discloses a polymeric composition comprising (1) a compatibilizing polymer selected from the group consisting of ethylene vinyl acetate and ethylene alkyl acrylates, (2) a polyolefin, (3) a free radical generator and (4) a rubbery polymer which is comprised of repeat units which are derived from (a) butyl acrylate, or optionally a mixture of butyl acrylate and 2-ethylhexyl acrylate containing up to about 40 percent 2-ethylhexyl acrylate, (b) at least one member selected from the group consisting of methyl methacrylate, ethyl methacrylate, methyl acrylate and ethyl acrylate, (c) acrylonitrile, (d) styrene and (e) a crosslinking agent.

### BACKGROUND OF THE INVENTION

Automotive instrument panels and door panels are typically composites which are made of a rigid backing which supports a semi-rigid urethane foam with the semi-rigid urethane foam being covered with a skin compound. Such skin compounds are typically blends of polyvinyl chloride (PVC) with ABS (acrylonitrile/butadiene/styrene polymers) which are sometimes modified with nitrile rubber (NBR). The nitrile rubber is included in such blends as a permanent modifier for the PVC which provides it with a higher degree of flexibility.

There is a growing demand in the automotive industry for products that exhibit higher strength and durability. For instance, it is highly desirable for the skin compounds used in instrument and door panels to exhibit excellent tear strength. The automotive industry is also currently moving toward more aerodynamic body designs which typically include larger glass areas. Such design changes have significantly increased the heat and ultraviolet light aging requirements of automotive interiors. This has in turn significantly increased the demands put upon the polymers which are utilized as skins in automotive interior panels.

Heat and light stabilizers can be employed to improve the heat and ultraviolet light aging characteristics of conventional PVC/ABS/NBR blends which are utilized as skins for automotive interior panels. However, the degree to which the aging characteristics of such blends can be improved by the addition of additives is limited. In fact, there is a demand for performance characteristics in such applications which heretofore has not been realized by the utilization of heat and light stabilizers. For instance, it would be highly desirable for the skins used in automotive panels to resist discoloration and cracking under conditions of high heat and intense ultraviolet light throughout the life of the vehicle.

NBR/ABS/PVC blends offer an array of physical properties which make them useful as a skin composition for automotive panels. The NBR acts as a permanent flexibilizing monomer for the PVC. It also acts as a shrinkage control agent, and embossing aid, and improves grain retention. The NBR in such blends further provides vacuum forming gauge control and exhibits low fog characteristics. NBR is highly compatible with PVC and has the capability of being recycled.

U.S. Pat. Nos. 5,380,785, 5,415,940, 5,504,155, 5,504,160 and 5,616,651 disclose a rubbery polymer which can be blended with PVC to make leathery compositions. These compositions are particularly useful in manufacturing skins for automotive interior paneling. Skin compositions which are made utilizing this rubbery polymer provide a higher level of resistance to heat and ultraviolet light than those made utilizing conventional NBR/ABS/PVC blends. The rubbery polymers disclosed by these patents also offer low fog characteristics, low odor, shrinkage control and grain retention. They also act as an embossing aid and as a permanent flexibilizing modifier. However, one drawback to these rubbery polymer/polyvinyl chloride blends is that they contain a halogen.

There is currently a demand for skin compositions having excellent tear resistance as well as excellent heat and ultra-violet light resistance that do not contain halogens, such as polyvinyl chloride. This is because industry in general and the automotive industry in particular are attempting to reduce the amount of halogenated materials in industrial products for improved recyclability and other environmental reasons.

### SUMMARY OF THE INVENTION

This invention is based upon the discovery that the tear strength and tensile strength of blends of certain rubbery polymers with polyolefins that are compatibilized with ethylene alkyl acrylates or ethylene vinyl acetate copolymers can be significantly improved by crosslinking the rubbery polymer with a free radical generator. These blends can be made so as to be useful as skins for automotive interior panels and can be made so as to be leathery in nature. The blends of this invention are also highly useful in coating electrical cables.

This invention relates to a polymeric composition that can be blended with a polyolefin polymer and subsequently crosslinked to make a tear resistant composition having excellent heat and ultra violet light resistance. More specifically, this invention discloses a polymeric composition comprising (1) a compatibilizing polymer selected from the group consisting of ethylene vinyl acetate and ethylene alkyl acrylates, (2) a free radical generator and (3) a rubbery polymer which is comprised of repeat units which are comprised of (a) butyl acrylate, or optionally a mixture of butyl acrylate and 2-ethylhexyl acrylate containing up to about 40 percent 2-ethylhexyl acrylate, (b) at least one member selected from the group consisting of methyl methacrylate, ethyl methacrylate, methyl acrylate and ethyl acrylate, (c) acrylonitrile, (d) styrene and (e) a crosslinking agent.

The subject invention also reveals a polymeric composition comprising (1) a compatibilizing polymer selected from the group consisting of ethylene vinyl acetate and ethylene alkyl acrylates, (2) a polyolefin, (3) a free radical generator and (4) a rubbery polymer which is comprised of repeat units which are comprised of (a) butyl acrylate, or optionally a mixture of butyl acrylate and 2-ethylhexyl acrylate containing up to about 40 percent 2-ethylhexyl acrylate, (b) at least one member selected from the group consisting of methyl methacrylate, ethyl methacrylate, methyl acrylate and ethyl acrylate, (c) acrylonitrile, (d) styrene and (e) a crosslinking agent. Such polymeric compositions can be crosslinked to form a high tensile strength composition having excellent heat and ultra-violet light resistance.

### DETAILED DESCRIPTION OF THE INVENTION

The rubbery polymers that can be utilized in making the blends of this invention are synthesized utilizing a free radical emulsion polymerization technique. These rubbery polymers are comprised of repeat units which are derived from (a) butyl acrylate, or optionally a mixture of butyl acrylate and 2-ethylhexyl acrylate containing up to about 40 percent 2-ethylhexyl acrylate, (b) methyl methacrylate, ethyl methacrylate, methyl acrylate or ethyl acrylate, (c) acrylonitrile, (d) styrene and (e) a crosslinking agent. The crosslinking agent is typically a multi-functional acrylate, a multi-functional methacrylate or divinylbenzene. Some specific examples of crosslinking agents which can be used include ethylene glycol methacrylate, divinylbenzene and 1,4-butanediol dimethacrylate.

Technically, the rubbery polymers of this invention contain repeat units (chain linkages) which are derived from (a) butyl acrylate, or optionally a mixture of butyl acrylate and 2-ethylhexyl acrylate containing up to about 40 percent 2-ethylhexyl acrylate, (b) methyl methacrylate, ethyl methacrylate, methyl acrylate or ethyl acrylate, (c) acrylonitrile, (d) styrene and (e) a crosslinking agent. These repeat units differ from the monomers that they were derived from in that they contain one less carbon-carbon double bond than is present in the respective monomer. In other words, a carbon-to-carbon double bond is consumed during the polymerization of the monomer into a repeat unit in the rubbery polymer. Thus, in saying that the rubbery polymer contains various monomers, in actuality means that it contains repeat units which are derived from those monomers.

The rubbery polymers of this invention will normally contain (a) from about 40 weight percent to about 80 weight percent butyl acrylate, or optionally a mixture of butyl acrylate and 2-ethylhexyl acrylate containing up to 40 weight percent 2-ethylhexyl acrylate, (b) from about 5 weight percent to about 35 weight percent methyl methacrylate, ethyl methacrylate, methyl acrylate or ethyl acrylate, (c) from about 4 weight percent to about 30 weight percent acrylonitrile, (d) from about 3 weight percent to about 25 weight percent styrene and (e) from about 0.25 weight percent to about 8 weight percent of a crosslinking agent.

Such rubbery polymers will preferably contain (a) from about 50 weight percent to about 80 weight percent butyl acrylate, or optionally a mixture of butyl acrylate and 2-ethylhexyl acrylate containing up to about 40 percent 2-ethylhexyl acrylate, (b) from about 3 weight percent to about 25 weight percent of at least one member selected from the group consisting of methyl methacrylate, ethyl methacrylate, methyl acrylate and ethyl acrylate, (c) from about 6 weight percent to about 30 weight percent acrylonitrile, (d) from about 5 weight percent to about 18 weight percent styrene and (e) from about 0.5 weight percent to about 4 weight percent of a crosslinking agent.

The rubbery polymer will more preferably be comprised of repeat units which are derived (a) from about 55 weight percent to about 75 weight percent butyl acrylate, or optionally a mixture of butyl acrylate and 2-ethylhexyl acrylate containing up to about 40 percent 2-ethylhexyl acrylate, (b) from about 5 weight percent to about 20 weight percent of at least one member selected from the group consisting of methyl methacrylate, ethyl methacrylate, methyl acrylate and ethyl acrylate, (c) from about 10 weight percent to about 25 weight percent acrylonitrile, (d) from about 8 weight percent to about 14 weight percent styrene and (e) from about 1 weight percent to about 3 weight percent of a crosslinking agent. The percentages reported in this paragraph are based upon the total weight of the rubbery polymer.

The rubbery polymers utilized in the blends of this invention are synthesized in an aqueous reaction mixture by utilizing a free radical polymerization technique. The reaction mixture utilized in this polymerization technique is comprised of water, the appropriate monomers, a suitable free radical initiator, a crosslinking agent and a soap. The reaction mixture utilized in this polymerization technique will normally contain from about 10 weight percent to about 80 weight percent monomers, based upon the total weight of the reaction mixture. The reaction mixture will preferably contain from about 20 weight percent to about 70 weight percent monomers and will more preferably contain from about 40 weight percent to about 50 weight percent monomers.

The reaction mixtures utilized in carrying out such polymerizations will typically contain from about 0.05 phm (parts per hundred parts of monomer by weight) to about 3 phm of at least one member selected from the group consisting of metal salts of alkyl sulfates and metal salts of alkyl sulfonates. It is generally preferred for the reaction mixture to contain from about 0.1 phm to about 2.5 phm of the metal salt of the alkyl sulfonate or the metal salt of the alkyl sulfate. It is normally more preferred for the reaction mixture to contain from about 0.5 phm to about 2 phm of the metal salt of the alkyl sulfonate or the metal salt of the alkyl sulfate.

The sulfonate surfactants that are useful in synthesizing the rubbery polymers used in the blends of this invention are commercially available from a wide variety of sources. For instance, Du Pont sells sodium alkylarylsulfonate under the tradename Alkanol™, Browning Chemical Corporation sells sodium dodecylbenzene sulfonates under the tradename Ufaryl™ D1-85 and Ruetgers-Nease Chemical Company sells sodium cumene sulfonate under the tradename Naxonate Hydrotrope™. Some representative examples of sulfonate surfactants which can be used include sodium toluene-xylene sulfonate, sodium toluene sulfonate, sodium cumene sulfonates, sodium decyldiphenylether sulfonate, sodium dodecylbenzenesulfonate, sodium dodecyldiphenylether sulfonate, sodium 1-octane sulfonate, sodium tetradecane sulfonate, sodium pentadecane sulfonate, sodium heptadecane sulfonate and potassium toluene sulfonate.

Metal salts of alkylbenzene sulfonates are a highly preferred class of sulfonate surfactant. The metal will generally be sodium or potassium with sodium being preferred. Sodium salts of alkylbenzene sulfonates have the structural formula:

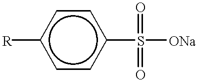

wherein R represents an alkyl group containing from 1 to about 20 carbon atoms. It is preferred for the alkyl group to contain from about 8 to about 14 carbon atoms.

Other soaps, such as half ester maleate soaps, can also be used. The half ester maleate soap utilized in the polymerization is prepared by reacting maleic anhydride with a fatty alcohol containing from about 10 to about 24 carbon atoms. It is typically preferred to utilize a fatty alcohol which contains from about 12 to about 16 carbon atoms. One mole of the maleic anhydride is reacted with one mole of the fatty alcohol in producing the half ester maleate soap. This reaction is typically conducted at a temperature which is within the range of about 50° C. to about 80° C. and can be depicted as follows:

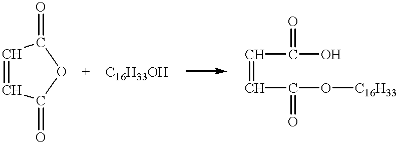

Sodium hydroxide or potassium hydroxide is then typically added to make the half ester maleate soap. This step can be depicted as follows:

[chemical structure]

The free radical polymerization technique utilized in this synthesis is normally initiated by including a free radical initiator in the reaction mixture. Virtually, any type of compound capable of generating free radicals can be utilized as the free radical initiator. The free radical generator is normally employed at a concentration within the range of about 0.01 phm to about 1 phm. The free radical initiators which are commonly used include the various peroxygen compounds such as potassium persulfate, ammonium persulfate, benzoyl peroxide, hydrogen peroxide, di-t-butyl peroxide, dicumyl peroxide, 2,4-dichlorobenzoyl peroxide, decanoyl peroxide, lauryl peroxide, cumene hydroperoxide, p-menthane hydroperoxide, t-butyl hydroperoxide, acetyl peroxide, methyl ethyl ketone peroxide, succinic acid peroxide, dicetyl peroxydicarbonate, t-butyl peroxyacetate, t-butyl peroxymaleic acid, t-butyl peroxybenzoate, acetyl cyclohexyl sulfonyl peroxide, and the like; the various azo compounds such as 2-t-butylazo-2-cyanopropane, dimethyl azodiisobutyrate, azodiisobutylronitrile, 2-t-butylazo-1-cyanocyclohexane, 1-t-amylazo-1-cyanocyclohexane, and the like, the various alkyl perketals, such as 2,2-bis-(t-butyl-peroxy)butane, and the like. Water-soluble peroxygen-free radical initiators are especially useful in such aqueous polymerizations.

The emulsion polymerizations of this invention are typically carried out at the temperature ranging between about 60° F. (20° C.) and 190° F. (88° C.). At temperatures above about 88° C., alkyl acrylate monomers, such as butyl acrylate, have a tendency to boil. Thus, a pressurized jacket would be required for heating such alkyl acrylate monomers to temperatures in excess of about 88° C. On the other hand, at polymerization temperatures of less than about 55° C., a redox initiator system is required to insure satisfactory polymerization rates.

The free radical emulsion polymerization utilized in synthesizing the rubbery polymers employed in the blends of this invention are typically conducted at a temperature which is within the range of about 10° C. to about 95° C. In most cases, the polymerization temperature utilized will vary between about 20° C. and about 80° C. The polymerization is carried out as a two-step batch process. In the first step, a seed polymer containing latex is synthesized. This is done by polymerizing (a) butyl acrylate, or optionally a mixture of butyl acrylate and 2-ethylhexyl acrylate containing up to about 40 percent 2-ethylhexyl acrylate, (b) at least one member selected from the group consisting of methyl methacrylate, ethyl methacrylate, methyl acrylate and ethyl acrylate, (c) acrylonitrile and (d) a crosslinking agent.

The seed polymer containing latex is typically prepared by the polymerization of a monomer mixture which contains about 40 to about 90 weight percent butyl acrylate, or optionally a mixture of butyl acrylate and 2-ethylhexyl acrylate containing up to about 40 percent 2-ethylhexyl acrylate, from about 5 to about 35 weight percent methyl methacrylate, ethyl methacrylate, methyl acrylate or ethyl acrylate, from about 2 to about 30 weight percent acrylonitrile and from about 0.25 weight percent to 6 weight percent of the crosslinking agent. It is typically preferred for the monomeric component utilized in the first step to include about 50 weight percent to about 85 weight percent butyl acrylate, or optionally a mixture of butyl acrylate and 2-ethylhexyl acrylate containing up to about 40 percent 2-ethylhexyl acrylate, from about 5 weight percent to about 30 weight percent ethyl acrylate, ethyl methacrylate, methyl acrylate or methyl methacrylate, from about 4 weight percent to about 28 weight percent acrylonitrile and from about 0.5 weight percent to about 4 weight percent of the crosslinking agent. It is generally more preferred for the monomer charge composition used in synthesizing the seed polymer latex to contain from about 60 weight percent to about 80 weight percent butyl acrylate, or optionally a mixture of butyl acrylate and 2-ethylhexyl acrylate containing up to about 40 percent 2-ethylhexyl acrylate, from about 5 weight percent to about 25 weight percent methyl methacrylate, ethyl methacrylate, methyl acrylate or ethyl acrylate, from about 5 weight percent to about 25 weight percent acrylonitrile and from about 1 to about 3 weight percent crosslinking agent.

After the seed polymer latex has been prepared, styrene monomer, additional acrylonitrile monomer and additional crosslinking agent is added to the seed polymer containing latex. As a general rule, from about 4 parts by weight to about 30 parts by weight of styrene, from about 1 part by weight to about 20 parts by weight of additional acrylonitrile and from about 0.01 to 2 parts by weight of the crosslinking agent will be added. In this second stage of the polymerization, it is preferred to add from about 6 parts by weight to about 22 parts by weight of styrene, from about 3 parts by weight to about 12 parts by weight of acrylonitrile and from about 0.05 parts by weight to 1 part by weight of the crosslinking agent. It is typically more preferred for from about 10 parts by weight to about 17 parts by weight of styrene, from about 4 parts by weight to about 8 parts by weight of acrylonitrile and from about 0.1 parts by weight to about 0.5 parts by weight of the crosslinking agent to be added to the seed polymer latex to initiate the second phase of the polymerization.

A wide variety of crosslinking agents can be utilized in carrying out the polymerizations of this invention. Some representative examples of crosslinking agents which can be utilized include difunctional acrylates, difunctional methacrylates, trifunctional acrylates, trifunctional methacrylates and divinylbenzene. Proven to be particularly useful as the crosslinking agent is 1,4-butanediol dimethacrylate.

In most cases, the polymerization will be continued until a high monomer conversion has been attained. After the polymerization has been completed, it is normally desirable to add an aminoalcohol to the emulsion to deodorize the latex. The aminoalcohol will generally be of the structural formula HO—A—NH₂, wherein A represents an alkylene group which contains from 2 to about 20 carbon atoms. It is normally preferred for the aminoalcohol to contain from 2 to about 10 carbon atoms with amino alcohols which contain from 2 to about 5 carbon atoms being most preferred. Ethanolamine (HO—CH₂—CH₂—NH₂) which is also known as 2-aminoethanol and 2-hydroxyethylamine is a representative example of a highly preferred aminoalcohol. Some additional examples of preferred aminoalcohols include 3-aminopropanol, 4-aminobutanol, 2-amino-2-methyl-1-propanol, 2-amino-2-ethyl-1,3-propanediol, N-methyl-2,2-iminoethanol and 5-aminopentanol.

This deodorizing step will be carried out under conditions which allow for the aminoalcohol to react with residual n-butyl acrylate and acrylonitrile which is present in the emulsion. This reaction will proceed over a broad temperature range and the deodorizing step can be conducted at any temperature which is within the range of about 5° C. and about 95° C. However, for practical reasons, the deodorizing step will normally be carried out at a temperature which is within the range of about 20° C. to about 70° C. Since the reaction is faster at higher temperatures, the amount of reaction time needed will decrease with increasing temperature. For instance, at a temperature of about 20° C., a residence time in the deodorizing step of one to three days may be required. On the other hand, at a temperature of about 65° C., only about two hours of reaction time is normally required.

The amount of time required for the aminoalcohol to react with the residual n-butyl acrylate monomer and residual acrylonitrile monomer will also depend upon the level of aminoalcohol utilized. As a general rule, from about 0.05 weight percent to about 2 weight percent of the aminoalcohol will be added, based upon the total weight of the emulsion. More typically, from about 0.1 weight percent to about 1.5 weight percent of the aminoalcohol will be added. It is normally preferred to utilize from about 0.3 weight percent to about 1 weight percent of the aminoalcohol.

The rubbery polymer made by the two-step batch polymerization process is recovered from the emulsion (latex) after the optional deodorizing step. This can be accomplished by utilizing standard coagulation techniques. For instance, coagulation can be accomplished by the addition of salts, acids or both to the latex.

After the rubbery polymer is recovered by coagulation, it can be washed to further reduce odors. This can be accomplished by simply pouring or spraying water on the rubbery polymer. The rubbery polymer can also be washed by putting it in a water bath which will further reduce odor. After being washed, the rubbery polymer is generally dried.

It is sometimes advantageous to convert the dry rubbery polymer into a powder to facilitate its usage. In this case, it will be beneficial to add a partitioning agent to the rubbery polymer. Some representative examples of partitioning agents which can be employed include calcium carbonate, emulsion polyvinyl chloride and silica. Calcium carbonate is a highly desirable partitioning agent which can be utilized in such applications.

U.S. Pat. No. 5,616,651 describes a process for synthesizing rubbery polymers that can be employed in the blends of this invention in detail. The teachings of U.S. Pat. No. 5,616,651 are accordingly incorporated herein by reference in their entirety. Rubbery polymers that can be used in the practice of this invention are also sold by The Goodyear Tire & Rubber Company as Sunigum® rubber.

Some representative examples of ethylene alkylacrylate polymers that can be used as compatibilizing polymers in the blends of this invention include ethylene/methyl acrylate copolymers, ethylene/ethyl acrylate copolymers, ethylene/propyl acrylate copolymers, ethylene/butyl acrylate copolymers, ethylene/butyl acrylate/carbon monoxide terpolymers, ethylene/ethyl acrylate/maleic anhydride terpolymers and ethylene/acrylate/glycidyl methacrylate terpolymers. The ethylene-vinyl acetate (EVA) copolymers that can be used as compatibilizing polymers in the practice of this invention will typically contain from about 7 weight percent to 40 weight percent of the vinyl acetate monomer. Such ethylene-vinyl acetate copolymers are commercially available from a wide variety of sources. For instance, Du Pont sells ethylene-vinyl acetate copolymers under the trade name Elvax® and Elf-Atochem sells ethylene-vinyl acetate copolymers under the trade name Evatane®.

A wide variety of polyolefins can be utilized in the blends of this invention. Some representative examples of polyolefins that can be used include polyethylene, polyethylene synthesized with metallocene catalyst systems, polypropylene, polyethylene/polypropylene copolymers and other thermoplastic polyolefins.

The free radical generator can be virtually any chemical compound that will produce free radicals when heated to a temperature of at least about 90° C. The free radical generator will preferably produce free radicals after being heated to a temperature of at least about 100° C. The free radical generators that can be utilized include 2,2′-azo-bis(2-acetoxypropane), 2,5-dimethyl-2,5-bis(tert-butyl-peroxy)-hexyne, 2,5-dimethyl-2,5-bis(tert-butyl-peroxy)-hexane, dibutyl peroxide, tert-butylcumyl peroxide, bis(2-tert-butylperoxypropyl-(2))-benzene, dicumyl peroxide, bis(tert-butyl)-3,3 ethylene butyrate, bis(tert-butyl) 4,4-butyl valerate, tert-butyl peroxy-3,5,5 trimethylhexanoate, tert-butyl perbenzoate, and bis(tert-butyl peroxy) 1,1-trimethyl-3,3,5-cyclohexane, and the like. It is normally preferred to use a peroxide as the free radical generator.

The polymeric compositions described herein can be made by initially blending the compatibilizing polymer, the free radical generator and the rubbery polymer in a first step. This step can be conducted at a temperature which is either below or above the temperature at which the free radical generator produces free radicals. For instance, it can be carried out at a temperature below the decomposition temperature of a peroxide that was used as the free radical generator. The desired polyolefin can subsequently be blended into the blend of the compatibilizing polymer, the free radical generator and the rubbery polymer in a second mixing step. This step must be conducted at a temperature above the temperature at which the free radical generator produces free radicals in the event that the first step is conducted at a lower temperature. The four components of the blend can, of course, also be mixed together in a single mixing step which is carried out above the temperature at which the free radical generator produces free radicals.

It is highly preferred for the rubbery polymer to be in powdered form when blended with the other components of the blend. It is also preferred for a cocuring agent, such as 1,1′-(methylene-4,1-phenylene) bis-maleimide, m-phenylene-diamine-bis maleimide, triallyl cyanurate, triallyl isocyanurate, diallyl terephthalate, diallyl fumarate, triallyl mellitate, triallyl citrate, triallyl phosphate, trimethylol propane trimethacrylate, diallyl phthalate, ethylene-glycol-dimethacrylate, m-phenylene-diamine-bis-maleic-imid, sulphur, or the like, to be included in the blend to reduce the mixing time required to crosslink the rubbery polymer. For a list of suitable cocuring agents, see T H Kempermann, Rubber Chem & Tech, July/August 1988, Volume 61, No 3.

The blends of this invention will typically contain from about 10 parts to about 1000 parts of the polyolefin polymer, from about 1 part to about 200 parts by weight of the compatibilizing polymer, about 0.05 parts to about 10 parts of the free radical generator, and optionally, about 0.05 parts to about 10 parts of the cocuring agent per 100 parts by weight of the rubbery polymer. It is typically preferred for the leathery compositions of this invention to contain from about 20 parts to about 400 parts of the polyolefin polymer, from about 5 to about 100 parts by weight of the compatibilizing polymer, about 0.1 parts to about 6 parts of the free radical generator, and optionally, about 0.1 parts to about 6 parts of the cocuring agent per 100 parts by weight of the rubbery polymer. It is typically most preferred for the leathery compositions of this invention to contain from about 30 parts to about 300 parts of the polyolefin polymer, from about 10 to about 50 parts by weight of the compatibilizing polymer, about 0.2 parts to about 4 parts of the free radical generator, and optionally, about 0.2 parts to about 4 parts of the cocuring agent per 100 parts by weight of the rubbery polymer.

Various colorants and/or pigments will typically also be added to the composition to attain the desired color. A wide variety of plasticizers which are compatible with the polyolefin resin and/or the rubbery polymer can also optionally be employed.

The leathery compositions of this invention are useful in a wide variety of applications. For example, they have been found to be extremely valuable when used in making skins for automotive panels. Such panels are typically comprised of a semi-rigid foam which is supported by a rigid backing and covered with the leathery composition of this invention. Such skins are made by calendering or extruding the leathery compositions of this invention and then cutting them to the desired size and shape. Such skins for automotive applications which are made with the leathery compositions of this invention offer outstanding heat and ultraviolet light stability. These are highly desirable characteristics which can help to prevent the skin of automotive panels from cracking during the normal life of the vehicle.

This invention is illustrated by the following examples which are merely for the purpose of illustration and are not to be regarded as limiting the scope of the invention or the manner in which it can be practiced. Unless specifically indicated otherwise, all parts and percentages are given by weight.

### EXAMPLE 1 AND COMPARATIVE EXAMPLE 2

In this experiment, a blend of Sunigum® 7395 rubber and Elvax 360 ethylene-vinylacetate copolymer was made by mixing 70 parts of the ethylene-vinylacetate copolymer with 30 parts of the Sunigum® 7395 rubber. In Example 1, 0.125 phr of dicumyl peroxide (free radical generator) and 0.25 phr of 1,1′-(methylene-4,1-phenylene) bis-maleimide (cocuring agent) was also included in the blend. The free radical generator and the cocuring agent were not included in the blend made in Comparative Example 2. The samples were extruded at 160° C. at a rate of 10 kg/hour and were subsequently injection-molded at 180° C. Some of the physical properties of the two blends were determined and are reported in Table I.

TABLE I

| | | Comparative |
|---|---|---|
| | Example 1 | Example 2 |
| Shore A Hardness | 79 ± 1 | 75 ± 1 |
| Stress @ 50% | 3.6 MPa | 2.7 MPa |
| Stress @ 100% | 5.1 MPa | 3.3 MPa |
| Stress @ 200% | 7.0 MPa | 4.1 MPa |
| Tensile Strength | 9.1 MPa | 10.4 MPa |
| Strain at Break | 404 ± 86 | 707 ± 38 |
| (%) | | |
| Tear Strength | 49 ± 1 kN/m | 42 ± 2 kN/m |
| Parallel | | |
| Tear Strength | 53 ± 8 kN/m | 42 ± 2 kN/m |
| Perpendicular | | |

As can be seen from Table I, the compatibilized blend of this invention that was crosslinked with the dicumyl peroxide had much higher modulus and tear resistance than did the blend which was not crosslinked with a free radical generator. This experiment shows that the physical properties of compatibilized blends can be improved by including a free radical generator therein.

### EXAMPLE 3 AND COMPARATIVE EXAMPLE 4

In this experiment, a blend of Sunigum® 7395 rubber and Elvax 360 ethylene-vinylacetate copolymer was made by mixing 50 parts of the ethylene-vinylacetate copolymer with 50 parts of the Sunigum® 7395 rubber. In Example 3, 0.125 phr of dicumyl peroxide (free radical generator) and 0.25 phr of 1,1′-(methylene-4,1-phenylene) bis-maleimide (cocuring agent) was also included in the blend. The free radical generator and the cocuring agent were not included in the blend made in Comparative Example 4. The samples were extruded at 160° C. at a rate of 10 kg/hour and were subsequently injection-molded at 180° C. Some of the physical properties of the two blends were determined and are reported in Table II.

TABLE II

| | | Comparative |
|---|---|---|
| | Example 3 | Example 4 |
| Shore A Hardness | 74 ± 1 | 69 ± 1 |
| Stress @ 50% | 3.2 MPa | 2.3 MPa |
| Stress @ 100% | 4.7 MPa | 3.0 MPa |
| Stress @ 200% | 6.5 MPa | 4.1 MPa |
| Tensile Strength | 7.6 MPa | 7.2 MPa |
| Strain at Break | 328 ± 81 | 689 ± 79 |
| (%) | | |
| Tear Strength | 44 ± 5 kN/m | 38 ± 3 kN/m |
| Parallel | | |
| Tear Strength | 52 ± 6 kN/m | 40 ± 2 kN/m |
| Perpendicular | | |

As can again be seen from Table II, the compatibilized blend of this invention that was crosslinked with the dicumyl peroxide had much higher strength and tear resistance than did the blend which was not crosslinked with a free radical generator. This experiment shows that the physical properties of compatibilized blends can be improved by including a free radical generator therein.

### EXAMPLE 5 AND COMPARATIVE EXAMPLE 6

In this experiment, a blend of Sunigum® 7395 rubber and Elvax 360 ethylene-vinylacetate copolymer was made by mixing 30 parts of the ethylene-vinylacetate copolymer with 70 parts of the Sunigum® 7395 rubber. In Example 5, 0.125 phr of dicumyl peroxide (free radical generator) and 0.25 phr of 1,1′-(methylene-4,1-phenylene) bis-maleimide (cocuring agent) was also included in the blend. The free radical generator and the cocuring agent were not included in the blend made in Comparative Example 6. The samples were extruded at 160° C. at a rate of 10 kg/hour and were subsequently injection-molded at 180° C. Some of the physical properties of the two blends were determined and are reported in Table III.

TABLE III

| | | Comparative |
|---|---|---|
| | Example 5 | Example 6 |
| Shore A Hardness | 67 ± 1 | 60 ± 1 |
| Stress @ 50% | 2.8 ± 0.1 MPa | 1.9 ± 0.1 MPa |
| Stress @ 100% | 4.2 ± 0.2 MPa | 2.6 ± 0.1 MPa |
| Stress @ 200% | 6.2 ± 0.3 MPa | 3.9 ± 0.1 MPa |
| Tensile Strength | 7.2 ± 0.4 MPa | 5.7 ± 0.1 MPa |
| Strain at Break | 312 ± 58 | 627 ± 82 |
| (%) | | |
| Tear Strength | 32 ± 4 kN/m | 32 ± 5 kN/m |
| Parallel | | |
| Tear Strength | 35 ± 6 kN/m | 31 ± 2 kN/m |
| Perpendicular | | |

As can again be seen from Table III, the compatibilized blend of this invention that was crosslinked with the dicumyl peroxide had higher strength and tear resistance than did the blend which was not crosslinked with a free radical generator. This experiment shows that the physical properties of compatibilized blends can be improved by including a free radical generator therein.

### COMPARATIVE EXAMPLES 7-8 AND EXAMPLES 9-10

In this experiment, a blend of Sunigum® 7395 rubber and Elvax 360 ethylene-vinylacetate copolymer was made by mixing 80 parts of the ethylene-vinylacetate copolymer with 20 parts of the Sunigum® 7395 rubber. In Comparative Example 7, no free radical generator or cocuring agent was included. In Comparative Example 8, 1,1′-(methylene-4,1-phenylene) bis-maleimide was included as a cocuring agent, but no free radical generator was included in the blend. In Example 9, dicumyl peroxide was included in the blend as a free radical generator, but no cocuring agent was included in the blend. In Example 10, both a free radical generator and a cocuring agent were included in the blend. The samples were blended in a Haake rheocord internal mixer at 160° C. for 10 minutes and then compression-molded for 10 minutes. Some of the physical properties of the two blends were determined and are reported in Table IV.

TABLE IV

| Example | 7 | 8 | 9 | 10 |
|---|---|---|---|---|
| Peroxide (phr) | — | — | 0.25 | 0.25 |
| Cocuring Agent (phr) | — | 0.5 | — | 0.5 |
| Shore A Hardness | 75 | 76 | 77 | 80 |
| Maximum Stress (MPa) | 10.9 | 11.2 | 13.7 | 12.7 |
| 50% Modulus (MPa) | 2.8 | 2.7 | 3.1 | 3 |
| 200% Modulus (MPa) | 3.9 | 3.7 | 5.5 | 5 |
| Strain at Break (%) | 820 | 827 | 692 | 659 |
| Tear Strength (kN/m) | 36 | 36 | 46 | 43 |

As can be seen from Table IV, it was critical for the free radical generator to be included in the blend to attain improved physical properties. However, it was not critical for the cocuring agent to be present. In any case, it is preferred for a cocuring agent to be included in the blend to reduce the time required in the mixing step.

### COMPARATIVE EXAMPLES 11-12 AND EXAMPLES 13-14

In this experiment, a blend of Sunigum® 7395 rubber and Elvax 360 ethylene-vinylacetate copolymer was made by mixing 60 parts of the ethylene-vinylacetate copolymer with 40 parts of the Sunigum® 7395 rubber. In Comparative Example 11, no free radical generator or cocuring agent was included. In Comparative Example 12, 1,1′-(methylene-4,1-phenylene) bis-maleimide was included as a cocuring agent, but no free radical generator was included in the blend. In Example 13, dicumyl peroxide was included in the blend as a free radical generator, but no cocuring agent was included in the blend. In Example 14, both a free radical generator and a cocuring agent were included in the blend. The samples were blended in a Haake rheocord internal mixer at 160° C. for 10 minutes and then compression-molded for 10 minutes. Some of the physical properties of the two blends were determined and are reported in Table V.

TABLE V

| Example | 11 | 12 | 13 | 14 |
|---|---|---|---|---|
| Peroxide (phr) | — | — | 0.25 | 0.25 |
| Cocuring Agent (phr) | — | 0.5 | — | 0.5 |
| Shore A Hardness | 72 | 72 | 73 | 74 |
| Maximum Stress (MPa) | 6.2 | 6.4 | 8.9 | 8.8 |
| 50% Modulus (MPa) | 2.3 | 2.4 | 2.4 | 2.7 |
| 200% Modulus (MPa) | 3.4 | 3.7 | 4.4 | 5 |
| Strain at Break (%) | 698 | 731 | 610 | 610 |
| Tear Strength (kN/m) | 31 | 31 | 42 | 39 |

As can again be seen from Table V, it was critical for the free radical generator to be included in the blend to attain improved physical properties. However, it was not critical for the cocuring agent to be present. In any case, it is preferred for a cocuring agent to be included in the blend to reduce the time required in the mixing step.

### COMPARATIVE EXAMPLE 15 AND EXAMPLES 16-17

In this experiment, a blend of Sunigum® 7395 rubber, Engage 8100 polyethylene and Elvax 360 ethylene-vinylacetate copolymer was made by mixing 100 parts of Engage 8100 polyethylene, 30 parts of the ethylene-vinylacetate copolymer with 70 parts of the Sunigum® 7395 rubber. In Comparative Examples 15, a simple blend of the three polymers was made with no free radical generator or cocuring agent being included. In Example 16 and Example 17, both a free radical generator (0.125 phr of dicumyl peroxide) and a cocuring agent (0.25 phr of 1,1′(methylene-4-1-phenylene)bis maleimide) were included in the blend. In Example 16, the Sunigum® 7395 rubber and the Elvax 360 ethylene-vinylacetate copolymer were premixed in at a temperature of 160° C. in the presence of the free radical generator and the cocuring agent. The Engage polyethylene was then mixed with the blend of Sunigum® 7395 rubber and Elvax 360 ethylene-vinylacetate copolymer in a subsequent mixing step. In Example 17, all of the polymeric components were simultaneously mixed in a single mixing step. The samples were blended in a Haake rheocord internal mixer at 160° C. for 10 minutes and then compression-molded for 10 minutes. Some of the physical properties of the three blends were determined and are reported in Table VI.

TABLE VI

| Example | 15 | 16 | 17 |
|---|---|---|---|
| Peroxide (phr) | — | 0.125 | 0.125 |
| Cocuring Agent (phr) | — | 0.5 | 0.5 |
| Shore A Hardness | 65 | 66 ± 1 | 67 ± 1 |
| Tens Strength (MPa) | 6.9 ± 0.1 | 9.3 ± 0.3 | 9.3 ± 0.3 |
| 50% Modulus (MPa) | 1.6 ± 0.1 | 1.8 ± 0.0 | 1.8 ± 0.0 |
| 200% Modulus (MPa) | 2.9 ± 0.1 | 3.4 ± 0.1 | 3.5 ± 0.0 |
| Strain at Break (%) | 808 ± 13 | 833 ± 10 | 811 ± 13 |
| Tear Strength (kN/m) | 27.6 ± 0.4 | 31.4 ± 0.6 | 33.0 ± 0.3 |

As Examples 16 and 17 show the rubbery polymer, the compatibilizing polymer and the free radical generator can be mixed in a premixing step. Then, the premixed blend can be subsequently mixed with the polyolefin without sacrificing physical properties.

While certain representative embodiments and details have been shown for the purpose of illustrating the subject invention, it will be apparent to those skilled in this art that various changes and modifications can be made therein without departing from the scope of the subject invention.

What is claimed is:

1. A polymeric composition comprising (1) a compatibilizing polymer selected from the group consisting of ethylene vinyl acetate and ethylene alkyl acrylates, (2) a free radical generator and (3) a rubbery polymer which is comprised of repeat units which are comprised of (a) butyl acrylate, or optionally a mixture of butyl acrylate and 2-ethylhexyl acrylate containing up to about 40 percent 2-ethylhexyl acrylate, (b) at least one member selected from the group consisting of methyl methacrylate, ethyl methacrylate, methyl acrylate and ethyl acrylate, (c) acrylonitrile, (d) styrene and (e) a crosslinking agent.

2. A polymeric composition comprising (1) a compatibilizing polymer selected from the group consisting of ethylene vinyl acetate and ethylene alkyl acrylates, (2) a polyolefin, (3) a free radical generator and (4) a rubbery polymer which is comprised of repeat units which are comprised of (a) butyl acrylate, or optionally a mixture of butyl acrylate and 2-ethylhexyl acrylate containing up to about 40 percent 2-ethylhexyl acrylate, (b) at least one member selected from the group consisting of methyl methacrylate, ethyl methacrylate, methyl acrylate and ethyl acrylate, (c) acrylonitrile, (d) styrene and (e) a crosslinking agent.

3. A composition as specified in claim 1 wherein said compatibilizing polymer is ethylene vinyl acetate.

4. A composition as specified in claim 1 wherein said compatibilizing polymer is an ethylene alkyl acrylate.

5. A composition as specified in claim 4 wherein said ethylene alkyl acrylate is selected from the group consisting of ethylene alkylacrylate polymers that can be used in the blends of this invention include ethylene/methyl acrylate copolymers, ethylene/ethyl acrylate copolymers, ethylene/propyl acrylate copolymers, ethylene/butyl acrylate copolymers, ethylene/butyl acrylate/carbon monoxide terpolymers, ethylene/ethyl acrylate/maleic anhydride terpolymers and ethylene/acrylate/glycidyl methacrylate terpolymers.

6. A composition as specified in claim 2 wherein said polyolefin is polyethylene.

7. A composition as specified in claim 2 wherein said polyolefin is polypropylene.

8. A composition as specified in claim 2 wherein said polyolefin is an ethylene/propylene copolymer.

9. A composition as specified in claim 2 wherein said composition contains from about 10 parts to about 1000 parts of the polyolefin polymer and from about 1 to about 200 parts by weight of the compatibilizing polymer per 100 parts by weight of the rubbery polymer.

10. A composition as specified in claim 2 wherein said composition contains from about 20 parts to about 400 parts of the polyolefin polymer and from about 5 to about 100 parts by weight of the compatibilizing polymer per 100 parts by weight of the rubbery polymer.

11. A composition as specified in claim 2 wherein said composition contains from about 30 parts to about 300 parts of the polyolefin polymer and from about 10 to about 50 parts by weight of the compatibilizing polymer per 100 parts by weight of the rubbery polymer.

12. A composition as specified in claim 6 wherein said polyethylene was prepared with a metallocene catalyst.

13. A composition as specified in claim 1 wherein the free radical generator is present in an amount which is within the range of about 0.05 phr to about 10 phr.

14. A composition as specified in claim 13 which is further comprised of a cocuring agent.

15. A composition as specified in claim 14 wherein said cocuring agent is present in an amount which is within the range of about 0.05 phr to about 10 phr.

16. A composition as specified in claim 15 wherein the compatibilizing polymer is present in an amount which is within the range of about 1 phr to about 200 phr.

17. A composition as specified in claim 16 wherein the free radical generator is present in an amount which is within the range of about 0.1 phr to about 6 phr, wherein the cocuring agent is present in an amount which is within the range of about 0.1 phr to about 6 phr and wherein the compatibilizing polymer is present in an amount which is within the range of about 5 phr to about 100 phr.

18. A composition as specified in claim 16 wherein the free radical generator is present in an amount which is within the range of about 0.2 phr to about 4 phr, wherein the cocuring agent is present in an amount which is within the range of about 0.2 phr to about 4 phr and wherein the compatibilizing polymer is present in an amount which is within the range of about 10 phr to about 50 phr.

19. A composition as specified in claim 2 wherein the free radical generator is present in an amount which is within the range of about 0.05 phr to about 10 phr, wherein the cocuring agent is present in an amount which is within the range of about 0.05 phr to about 10 phr, wherein the polyolefin is present in an amount which is within the range of about 10 phr to about 1000 phr and wherein the compatibilizing polymer is present in an amount which is within the range of about 1 phr to about 200 phr.

20. A composition as specified in claim 2 wherein the free radical generator is present in an amount which is within the range of about 0.1 phr to about 6 phr, wherein the cocuring agent is present in an amount which is within the range of about 0.1 phr to about 6 phr, wherein the polyolefin is present in an amount which is within the range of about 20 phr to about 400 phr and wherein the compatibilizing polymer is present in an amount which is within the range of about 5 phr to about 100 phr.

21. A composition as specified in claim 2 wherein the free radical generator is present in an amount which is within the range of about 0.2 phr to about 4 phr, wherein the cocuring agent is present in an amount which is within the range of about 0.2 phr to about 4 phr, wherein the polyolefin is present in an amount which is within the range of about 30 phr to about 300 phr and wherein the compatibilizing polymer is present in an amount which is within the range of about 10 phr to about 50 phr.
